(19) United States
(12) Patent Application Publication
(10) Pub. No.: US 2019/0306142 A1
(43) Pub. Date: Oct. 3, 2019

(54) ACCOUNT AUTHORIZATION WITHOUT SHARING CONFIDENTIAL INFORMATION

(71) Applicant: CA, Inc., New York, NY (US)

(72) Inventors: Harmeet Singh Gujral, Bangalore (IN); Sanjaya Kumar Sahu, Bangalore (IN); Rohit Pathak, Bengaluru (IN); Vijay Kulkarni, Bangalore (IN)

(21) Appl. No.: 15/938,568

(22) Filed: Mar. 28, 2018

(51) Int. Cl. H04L 29/06; G06Q 20/40

(52) U.S. Cl. CPC H04L 63/083; H04L 67/10; G06Q 20/40

(57) ABSTRACT

A system includes a server computer system that may receive an authorization request from a first user for a transaction that includes a request for resources from a user account. The authorization request may include an identification value for a second, different user that has authorization authority for the user account. The server computer system may send transaction details to an authentication server that may make authorization determinations for the transaction based on a passcode and a reference value. The reference value may be generated based on the transaction details. The system may also receive confirmation data from the authentication server. This confirmation data may be generated by the authentication server based on the transaction details. The system may further send, to the first user, the passcode for communication to the second user, and may receive an indication whether the second user has authorized the transaction.

### BACKGROUND

### Technical Field

Embodiments described herein are related to the field of data security, and more particularly to establishing secure payment transactions.

### Description of the Related Art

Using computer systems, such as, for example, personal computers (PCs), laptops, smart phones, tablets, and other mobile and/or wearable devices, users may access a variety of data servers, cloud storage servers, online retailers, social media sites, and other networked computer services which may store sensitive information. These networked computer services may require the user to establish account credentials in order to access the sensitive information. In some situations, a first user that does not have credentials to access such information, may have a need or desire to access this sensitive information. Another user that does have credentials for accessing the sensitive information may approve of the first user's access to the sensitive information. In order to provide the access to the first user, the second user may need to be in a same room as the first user to provide the credentials on a same computer system that the first user is using, or, alternatively, the second user may choose to share the credentials with the first user.

### SUMMARY OF THE EMBODIMENTS

Various methods for embodiments of computer systems are disclosed. Broadly speaking, a system is contemplated that includes a server computer system that may receive an authorization request from a first user for a transaction that includes a request for resources from a user account. The authorization request may include an identification value that identifies a second, different user that has authorization authority for the user account. The server computer system may send transaction details to an authentication server that is configured to make authorization determinations for the transaction based on a passcode and a reference value. The reference value may be generated based on the transaction details. The server computer system may also receive confirmation data from the authentication server. This confirmation data may be generated by the authentication server based on the transaction details. The server computer system may further send, to the first user, the passcode for communication to the second user, and may receive, from the authentication server, an indication whether the second user has authorized the first user to perform the transaction. This indication may be generated based on whether the authentication server received, during a session in which the second user has been authenticated, the passcode and the reference value.

In another embodiment, an authentication server may receive, from a server computer system, transaction details corresponding to an authorization request, initiated by a first user, to complete a transaction that includes a request for resources from a user account. The authentication server may be configured to authorize the transaction based on receipt of first and second confirmation data from a second, different user that has authorization authority for the user account. This first confirmation data may be generated based on the transaction details. The authentication server may send, to the server computer system, the first confirmation data, and may receive a request from the second user to initiate a session. This request may include authorization credentials. The authentication server may receive, during the session with the second user, authorization data that includes the first confirmation data and the second confirmation data. The authentication server may send an indication whether the first user is authorized to complete the transaction. This indication may be based on the authorization data.

### BRIEF DESCRIPTION OF THE DRAWINGS

The following detailed description makes reference to the accompanying drawings, which are now briefly described.

FIG. 1 illustrates an embodiment of a system for authorizing a transaction by a second user for a first user.

FIG. 2 depicts an embodiment of another system for authorizing a transaction by a second user for a first user.

FIG. 3 shows a table depicting a flow of information during a transaction authorization.

FIG. 4 illustrates another table depicting a flow of information during a transaction authorization.

FIG. 5 depicts a flow diagram for an embodiment of a method for receiving and processing a request for a transaction authorization.

FIG. 6 shows a flow diagram for an embodiment of a method for authenticating a request for a transaction authorization.

FIG. 7 illustrates a flow diagram for an embodiment of a method for accessing an authentication server.

FIG. 8 depicts an embodiment of a system for authorizing a purchase request by a payer for a buyer.

FIG. 9 shows an embodiment of another system for authorizing a purchase request by a payer for a buyer.

FIG. 10 displays several views of a computer system used by a buyer to initiate a purchase request.

FIG. 11 represents several views of an automated teller machine (ATM) used by a payer to approve a purchase request.

FIG. 12 renders several views of a mobile device used by a payer to approve a purchase request.

FIG. 13 illustrates an embodiment of a computing device that may be used in the systems shown in the previous figures.

While the embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

As used throughout this disclosure, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION OF EMBODIMENTS

Situations may occur in which a first user wants authorization to complete a transaction for which this first user does not have the authority to approve. A second user with this approval authority may be willing to approve the transaction, but is unwilling to share credentials necessary to authorize the transaction with the first user. As an example, a college student may want to purchase goods to be paid for by a parent. The parent may be willing to fund the purchase, but may not wish to share bank account or credit card information with the student. If both the student and the parent are located near each other, then the parent may be able to join the student to make the purchase, either at a store or online from the student's or parent's residence. In contrast, if it is inconvenient for the parent to join the student, then either the parent shares the banking/credit card information with the student, thereby giving the student a capability to make further, unauthorized purchases, or the parent makes the purchase on behalf of the student, in which case there is a possibility of purchasing an incorrect item or general inconvenience.

In another example, a contractor may request a transfer of data from a client's database to a local computer system to complete contracted work for the client. This database may require authorization from a manager at the client. If the contractor and the manager are not co-located, then the options may include establishing temporary credentials for use by the contractor. Such temporary credentials, however, may provide more access to the database that the manager is willing to approve.

Methods and systems are disclosed herein which may enable a first person to generate a transaction that is then authorized by a second person, without the second person sharing authorization credentials with the first person. Such systems and methods may provide a fast and efficient method for transaction authorization without enabling additional unauthorized transactions.

It is noted that, as used herein, “online” refers to a connected state of a server computer, computer system, mobile device, or other computing device, to a wide area network, such as, for example, the Internet. A computing device said to be “online” when it is capable of being accessed by, or accessing, other computing devices connected to the network. In reference to an account, “online” refers to an account that is hosted by an online server or other type of online computing device, and, accordingly, may be accessed via the wide area network.

Embodiments described below are generally directed to an approval process in which a first user initiates a transaction on a server computer (which may also be referred to as a “requesting computer system”), which is ultimately approved (or not) by an authentication server (which may also be called an authenticating computer system) based on two pieces of information received from a second user: a “reference value” and a “passcode.” As used herein, a “reference value” is a value that is based at least in part on one or more attributes of the transaction (i.e., “transaction details”), while the “passcode” is a different, supplemental value used to enable the second user to approve or deny the associated transaction. Each of the passcode and the reference value may be generated using various methods and either value may be created by either the server computer or the authentication server.

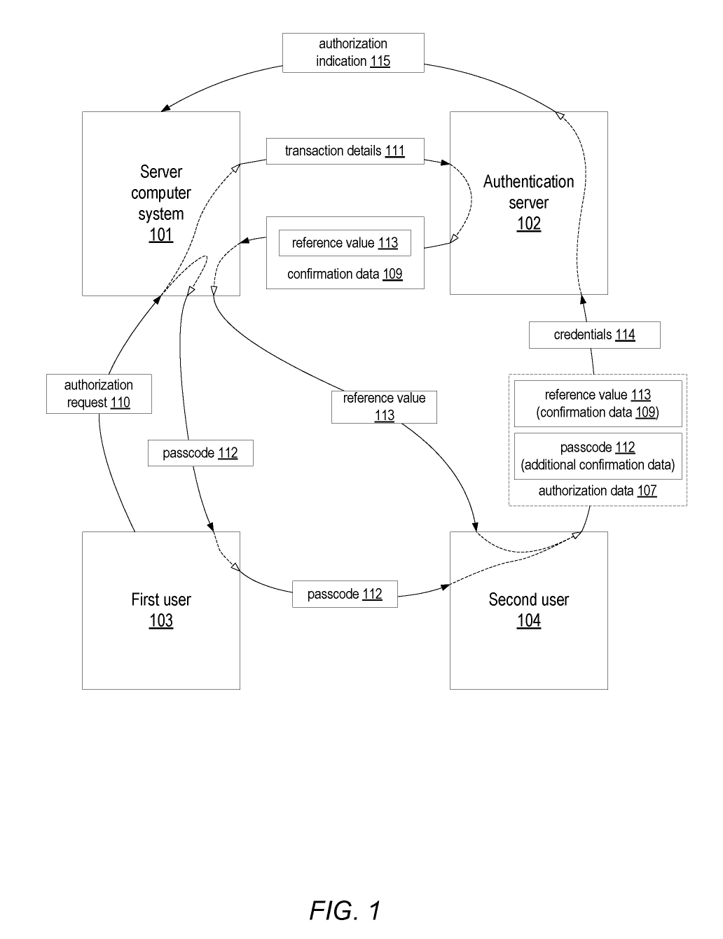

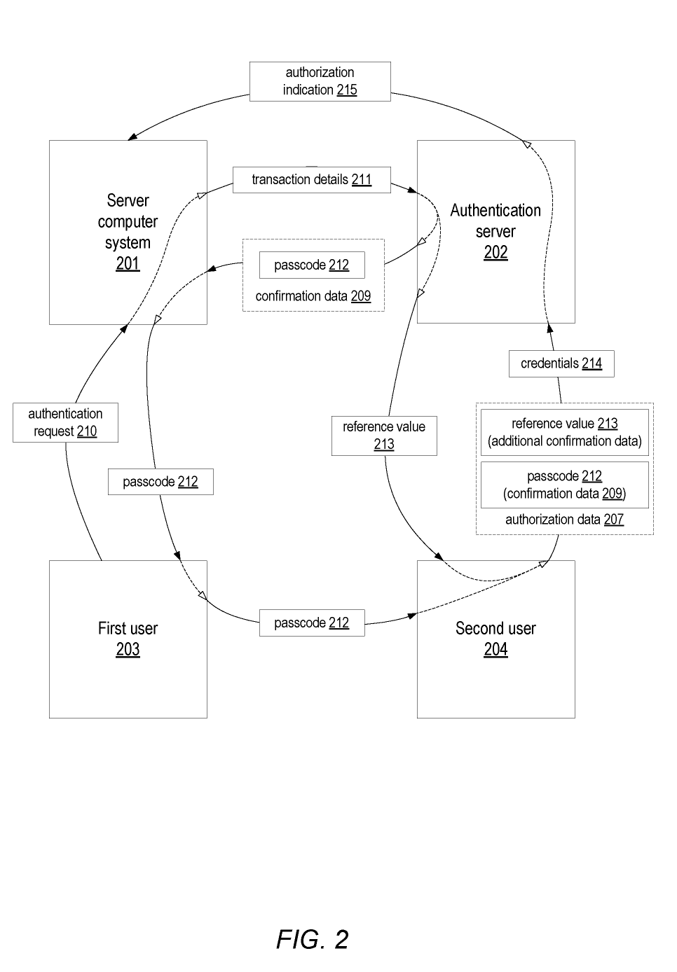

In general, after receiving a request for a transaction from a first user at the requesting computer system, this computer system sends transaction details (e.g., item purchased, amount, etc.) to the authentication server. As referred to herein, “transaction details” refers broadly to any identifying information about the transaction, including, but not limited to, details that may aid the second user in deciding to approve the transaction or not. Transaction details may include specifics of the transaction as well as information about the first user. In response, the authentication server then sends “confirmation data” back to the requesting computer system. The confirmation data includes, in various embodiments, at least the reference value or the passcode. FIG. 1 below describes an embodiment in which the authentication server includes a reference value in the confirmation data, while FIG. 2 below describes an embodiment in which the authentication server includes the passcode. The confirmation data may include both the reference value and passcode in other embodiments. In any event, FIGS. 1 and 2 show different methods for communicating the reference value and passcode to a second user with the authority to approve the transaction for the first user. Upon the authentication server receiving, from the second user, authorization data that includes the reference value and the passcode, the authentication server provides an authorization indication to the requesting computer system.

A representation of an embodiment of a system of networked computer systems capable of initiating a transaction by a first user and approving the transaction by a second user is shown in FIG. 1. The system of FIG. 1 includes server computer system 101 coupled to authentication server 102 and a computer system of first user 103, utilizing a multiuser computing network. Authentication server 102 is further coupled by a multiuser network to a computer system of second user 104. FIG. 1 also shows a flow of various pieces of information between the included computer systems and servers.

First user 103, in the illustrated embodiment, corresponds to a user utilizing any type of computer system that is capable of accessing the Internet, including, but not limited to, desktop computers, smart phones, tablet computers, notebook computers, smart home devices, smart watches, and the like. First user 103 sends authorization request 110 to server computer system 101. Server computer system 101 may correspond to one or more computer systems, coupled to a multiuser network connection, such as, for example, the Internet. Server computer system 101 may, in various embodiments, correspond to a server for one or more databases, a cloud computing system, an online merchant, or any other suitable server that generates a transaction based on receiving a request from a connected user. Authorization request 110 includes various items of information, including details of a particular transaction to be approved and contact information for second user 104 who can approve the transaction.

After receiving authorization request 110, server computer system 101 sends transaction details 111 to authentication server 102 as well as sending passcode 112 back to first user 103. In various embodiments, passcode 112 may be a randomly generated value, or may be based on some or all of data included in authorization request 110. For example, passcode 112 may correspond to all or a portion of an output of a hashing algorithm performed on the data received in authorization request 110. Transaction details 111 may include details that are included in authorization request 110 as well as additional information regarding the transaction that server computer system may need to complete the transaction. In some embodiments, passcode 112 may be included in transaction details 111.

In the illustrated embodiment, authentication server 102 corresponds to one or more computer systems, coupled to a multiuser network connection, such as, for example, the Internet. Authentication server 102 may, in various embodiments, correspond to a server for a bank or other financial institution, a secure access server, or any other suitable server that approves a transaction based on receiving correct credentials from an authorized approver. Authentication server 102 receives transaction details 111 from server computer system 101 and, in response, generates confirmation data 109 that includes reference value 113.

Reference value 113, in the illustrated embodiment, is a value that, for authentication server 102, is associated with transaction details 111. Authentication server 102 may use a given reference value to identify a particular transaction request, such that, at a given point in time, any active reference values each correspond to a single transaction request. A given reference value may remain active until the respective transaction request is either approved or denied. In some embodiments, a given reference value may also have a temporal limit, i.e., the given reference value may remain valid for a limited amount of time, such as, for example, for 24 hours, or 48 hours. In various embodiments, the amount of time may be determined by server computer system 101, authentication server 102, or second user 104.

In some embodiments, reference value 113 may be created by authentication server 102 based on data included in transaction details 111. For example, reference value 113 may be generated by applying a hashing algorithm to some or all of the data that is included with transaction details 111. In other embodiments, reference value 113 may be generated by authentication server 102 as a random value or a serialized value. Authentication server 102, for example, may utilize a random number generation circuit or application to generate a random value based on a random number generation algorithm and assign this random value to correspond to transaction details 111. As another example, authentication server 102 may utilized a range of values to assign as reference values and select a next, currently unused, value in the range to use as the reference value 113.

Authentication server 102, in the illustrated embodiment, sends confirmation data 109, including reference value 113, to server computer system 101. Server computer system 101, using the contact information received as part of authorization request 110, sends reference value 113 to second user 104. In various embodiments, server computer system 101 may send reference value 113 as an electronic message such as, e.g., a text message, an email, a message for a particular application, or as a voice message, or by any other suitable method. The method for sending the reference value 113 may be determined based on the contact information received by server computer system 101 from first user 103. For example, in one embodiment, the contact information may correspond to a user identification (ID). Server computer system 101 includes the user ID as part of transaction details 111 and authentication server 102 includes specific contact information with confirmation data 109, along with a preferred method for contacting second user 104.

In the illustrated embodiment, first user 103 sends passcode 112, received from server computer system 101, to second user 104. First user 103 may use any suitable method for sending passcode 112 to second user 104, including, e.g., email, text message, telephone, or a combination of these or other methods. In some embodiments, one or more intermediaries may be included in the communication of passcode 112 to second user 104. For example, first user 103 may send passcode 112 to a supervisor or manager, who then relays passcode 112 to second user 104.

After receiving both reference value 113 and passcode 112, second user 104 may initiate a session with authentication server 102. In the illustrated embodiment, this session corresponds to second user 104 logging into an account on authentication server 102 using credentials 114. Credentials 114 may correspond to at least a username and password, and, in some embodiments, may include additional information, such a value generated as part of a multi-factor authentication process.

After the session has been established, second user 104 provides authorization data 107 to authentication server 102. Authorization data 107, in the illustrated embodiment, includes passcode 112 and reference value 113. In some embodiments, second user 104 may submit reference value 113 to authentication server 102 before submitting passcode 112. Authentication server 102, in such an embodiment, may then send at least some of transaction details 111 to second user 104, thereby allowing second user 104 to review these details to make a determination if the transaction request will be approved or denied. If second user 104 approves the transaction request, then passcode 112 is sent to authentication server 102 and a final approval confirmation may be indicated by second user 104. Otherwise, if the transaction request is not approved, then second user 104, in some embodiments, may not send passcode 112 and, instead, indicate to authentication server 102 that the transaction request is denied. In other embodiments, both reference value 113 and passcode 112 may be sent regardless if the transaction request is approved or denied.

In the illustrated embodiment, authentication server 102 sends authorization indication 115 to server computer system 101. Authorization indication 115 includes one or more values that provide an indication to server computer system 101 if the transaction request is approved or denied. In some embodiments, if reference value 113 is valid for a limited amount of time, then authorization indication 115 may be sent with an indication of a transaction denial if the amount of time expires before receiving an approval indication from second user 104. Server computer system 101 may, in some embodiments, send an indication of approval or denial to first user 103. In other embodiments, server computer system 101 may only send an indication that authentication indication 115 has been received, but may not send first user 103 any indication if the request was approved or denied. In some embodiments, second user 104 may include a message to first user 103 as part of authorization data 107. This message may be transmitted by authentication server 102 to server computer system 101 which then relays the message to first user 103.

If the transaction request is approved, then, in some embodiments, first user 103 may complete the transaction by accessing server computer system 101. In other embodiments, server computer system 101 may complete the transaction without further input from first user 103.

It is noted that FIG. 1 is merely an example for demonstrating disclosed concepts. Only components and data movement necessary to illustrate these concepts are shown in FIG. 1. Additional and/or different components or data movements may be included in other embodiments.

Turning to FIG. 2, another representation of an embodiment of a system of networked computer systems capable of initiating a transaction by a first user and approving the transaction by a second user is shown in FIG. 2. The system of FIG. 2 is similar to the system of FIG. 1, including server computer system 201, authentication server 202, a computer system of first user 203, and a computer system of second user 204. Various items of information are shown being transferred between the included computer systems and servers, similar to the illustrations shown in FIG. 1. In the illustrated embodiment, the blocks shown in FIG. 2 correspond the similarly named and numbered blocks shown in FIG. 1 and, therefore, are as described in FIG. 1 with exceptions described below.

FIG. 2 shows a flow of information between the included computer systems and servers when processing a transaction request. In FIG. 2, however, this flow of information is different from FIG. 1. As described above, first user 203, in the illustrated embodiment, sends authorization request 210 to server computer system 201. Authentication request 210 may include contact information or an identification value for second user 204. After receiving authorization request 210, server computer system 201 sends transaction details 211 to authentication server 202. In addition to the information described above in regards to transaction details 111, transaction details 211 may include the contact information or identification value received with authentication request 210. Authentication server 202 receives transaction details 211 from server computer system 201 and, in response, generates confirmation data 209 that includes passcode 212. Passcode 212, in the illustrated embodiment, is generated by authentication server 202, but may otherwise correspond to passcode 112 in FIG. 1. In addition, authentication server 202 generates reference value 213 that includes similar information as described above in regards to FIG. 1.

In the illustrated embodiment, authentication server 202 sends confirmation data 209, including passcode 212, to server computer system 201. Authentication server 202 also sends, using contact information received as part of authorization request 210, reference value 213 to second user 204. In various embodiments, authentication server 202 may send reference value 213 as a text message, an email, a voice message, a message for a particular application, or by any other suitable method. Similar to the description for reference value 113 in FIG. 1, the method for sending reference value 213 may be determined based on the contact information received by server computer system 201 from first user 203. If, e.g., an identification value is received instead of contact information, then authentication server 202 may access stored records corresponding to the identification value and retrieve contact information as well as a preferred method for contacting second user 204.

Server computer system 201 receives passcode 212 as part of confirmation data 209. In the illustrated embodiment, server computer system 201 sends passcode 212 to first user 203. It is contemplated that, in other embodiments, authentication server 202 sends confirmation data 209, including passcode 212, directly to first user 203. In such an embodiment, authentication server 202 would receive contact information for first user 203 as well as for second user 204. First user 203, after receiving passcode 212, sends passcode 212 to second user 204. First user 203 may, optionally, include details describing the authorization request and transaction details in a message to second user 204 to aid in the decision to approve or deny the request to complete the transaction.

As described above in regards to FIG. 1, second user 204, initiates a session with authentication server 202 using credentials 214 and, during the session, sends authorization data 207, including reference value 213 and confirmation data 209 (or simply passcode 212) to authentication server 202. Authentication server 202 sends authorization indication 215 to server computer system 201 which indicates of second user 204 approved or denied the requested transaction.

It is noted that the system shown in FIG. 2 is an example embodiment. Only components and information needed to describe the disclosed concepts are illustrated. Variations of the example embodiment are contemplated and may include transmission of additional information.

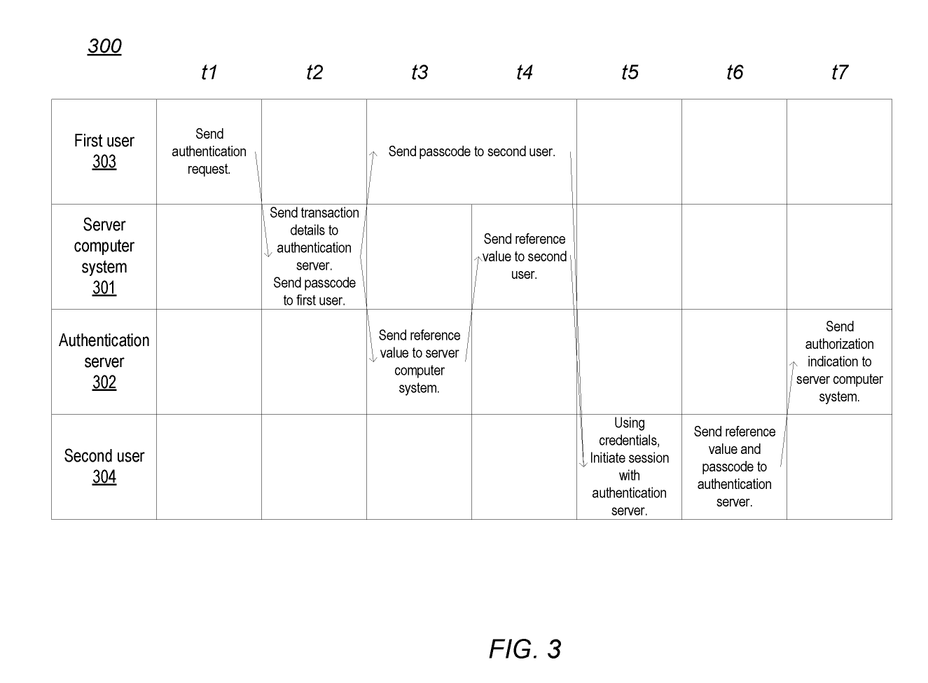

Moving to FIG. 3, a chart is depicted that shows a movement of data over time for an embodiment such as shown in FIG. 1. Four similar components as shown in FIG. 1 are included in chart 300: server computer system 301, authentication server 302, first user 303, and second user 304. These four components are as described for the similarly named and numbered blocks in FIG. 1. Various information is shown in a respective one of the four components throughout times t1 to t7.

In the illustrated embodiment, first user 303 sends, at time t1, a request for authentication to server computer system 301. The request may correspond to a request to complete a transaction between first user 303 and server computer system 301, such as, for example, a request to access restricted information in a database or a request to purchase goods from an online merchant. The request may include contact or other identifying information corresponding to second user 304.

At time t2, server computer system 301, in response to receiving the authentication request, sends transaction details to authentication server 302. These transaction details may include one or more of identifying information corresponding to first user 303, a type of transaction requested (e.g., a purchase of goods, a download of data, an upload of data, and the like), what is being requested (e.g., identification of specific goods or data), or any other details that may be used by second user 304 to make a decision whether to approve or deny the request. In addition to sending the transaction details to authentication server 302, server computer system 301 generates and sends a passcode to first user 303. This passcode may be a randomly generated value, such as, for example, a four to eight digit personal identification number (PIN), or a value determined based on some or all of the transaction details, e.g., a hash code generated by performing a hashing algorithm on the transaction details. In some embodiments, the passcode is also included in the transaction details sent to authentication server 302

At time t3 in the illustrated embodiment, in response to receiving the transaction details, authentication server 302 generates a reference value and sends this reference value to server computer system 301. The reference value may be generated based on the received transaction details, such as by performing a different hashing algorithm on the details, or an available value may be randomly or serially assigned to the received transaction details. Authentication server 302 may save the transaction details and the reference value in a local database for future reference. In some embodiments, the reference value may correspond to an index value to an entry in the local database where the transaction details are stored.

Proceeding to time t4, server computer system 301 sends the received reference value to second user 304. At some point during times t3 or t4, first user 303 sends the received passcode to second user 304. It is noted that second user 304 receives two items of information, the passcode and the reference value, from different entities, first user 303 and server computer system 301. These two items of information are needed by second user 304 to approve the transaction request. By receiving each item from a different source, second user 304 have an improved capability to identify an improper transaction request, such as a hacker attempting to impersonate first user 303 and/or server computer system 301 in an attempt to gain fraudulent approval of the transaction. Second user 304, if there is any doubt about the legitimacy, may perform additional actions to confirm with first user 303 and/or server computer system 301 that the transaction request is legitimate.

At time t5, second user 304 initiates a session with authentication server 302. Second user 304 may use a home or office computer, a mobile device, or another type of computing system to access authentication server 302 and initiates the session, for example, by logging into an account belonging to or otherwise associated with second user 304. During the session, at time t6, second user 304 may request the transaction details from authentication server 302 by entering the reference value. In some embodiments, the passcode may also be entered to view the details, while in other embodiments, the passcode may not be entered unless second user 304 is approving the transaction request. Second user 304 may enter additional details to confirm an approval or denial selection for the transaction request. Authentication server 302, at time t7, sends an authorization indication to server computer system 301, indicating if the transaction request has been approved or denied. Server computing system may complete the transaction if approved, or delete information associated with the request if it is denied.

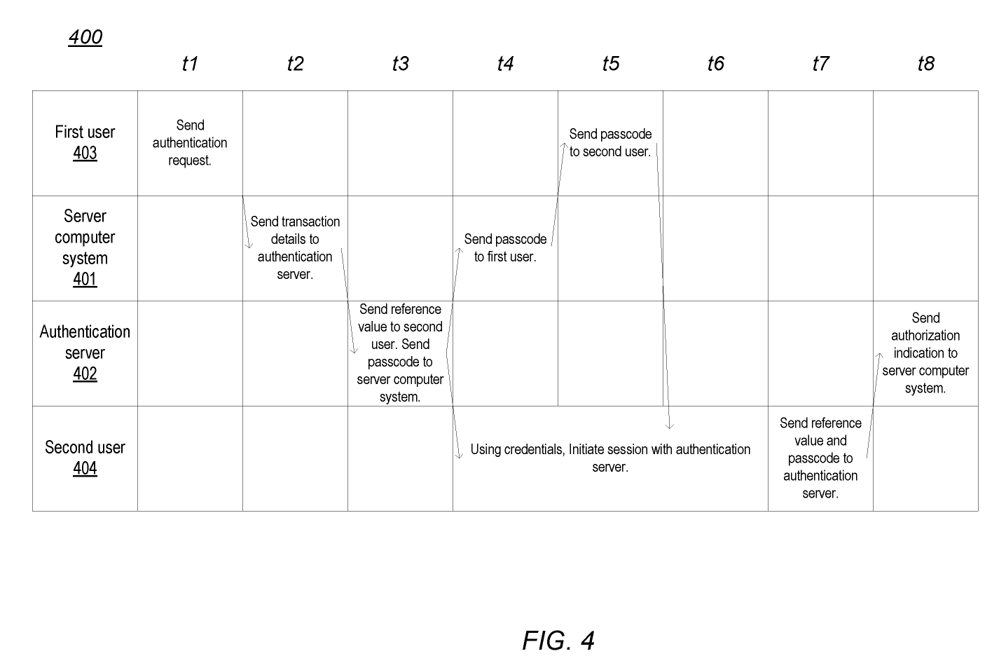

It is noted that FIG. 3 is merely one example used to demonstrate the disclosed concepts. The illustrated time periods, tl to t7, are intended only to indicate an order in which events occur, and not a measured unit of time. Other embodiments may differ in one or more characteristics. For example, the reference value and/or the passcode may be generated or sent by a different entity. The embodiment of FIG. 4 illustrates such a different embodiment.

Turning now to FIG. 4, another chart is presented, showing a movement of data over time for a different embodiment, such as the embodiment of FIG. 2. Like chart 300 of FIG. 3, chart 400 includes four components similar to those shown in FIG. 2: server computer system 401, authentication server 402, first user 403, and second user 404. Accordingly, these four components are as described for the similarly named and numbered blocks in FIG. 2. A flow of information is shown over times tl through t7.

Chart 400 begins at time t1 in a similar fashion as chart 300, with first user 403 sending a request for authentication to server computer system 401. In the illustrated embodiment, the request may correspond to a request to complete a transaction between first user 403 and server computer system 401, such as previously described. The request includes contact or other identifying information corresponding to second user 404. At time t2, server computer system 401 sends details of the requested transaction to authentication server 402. These details may include information regarding the transaction (e.g., regarding data, services, or goods involved in the transaction) as well as information regarding first user 403 and second user 404, such as contact or other identification information.

At time t3, authentication server 402, in the illustrated embodiment, generates a reference value and a passcode. Authentication server 402 may use a previously disclosed method for generating these items, or may use any other suitable method. One or more of the reference value, the transaction details, and the passcode, may be saved in a database or other form of storage local to authentication server 402. In some embodiments, the reference value may be used as an index value to an entry that includes the transaction details and/or passcode. The reference value is sent by authentication server 402 to second user 404 while the passcode is sent to server computer system 401. In other embodiments, authentication server 402 may send the passcode to first user 403 instead of, or in addition to, sending the passcode to server computer system 401. At time t4, server computer system sends the passcode to first user 403. First user 403 then, at time t5, sends the passcode to second user 404.

Second user 404, at some point in time from t4 to t6 initiates a session with authentication server 402. As described above, this session may correspond to second user 404 logging into an account hosted by authentication server 402 and owned or managed by second user 404. Second user 404 may send login credentials to authentication server 402 to initiate the session. Second user 404 may initiate the session at a point in time after receiving the reference value. During the session, at time t7, second user 404 sends the reference value to authentication server 402. In some embodiments, second user 404 may, at the same time, send the passcode, while, in other embodiments, the passcode may be sent later as a part of an approval process. After receiving the reference value, authentication server may retrieve details of the requested transaction and then send some or all of these details to second user 404. Second user 404 may utilize the transaction details to determine if the transaction request will be approved or denied. Second user 404 indicates either an approval or denial of the transaction request. Authorization server 402 sends this authorization indication to server computer system 401 which may complete the transaction if approved or otherwise cancel the transaction if denied. In some embodiments, server computer system 401 may further send the authorization indication to first user 403.

It is noted that chart 400 in FIG. 4 is an example embodiment. Variations of the example embodiment are contemplated and may include additional transmissions of information. As disclosed above in regards to chart 300, times t1 through t8 are not intended to represent a particular increment of time, but rather an order of occurrence of the various movements of information.

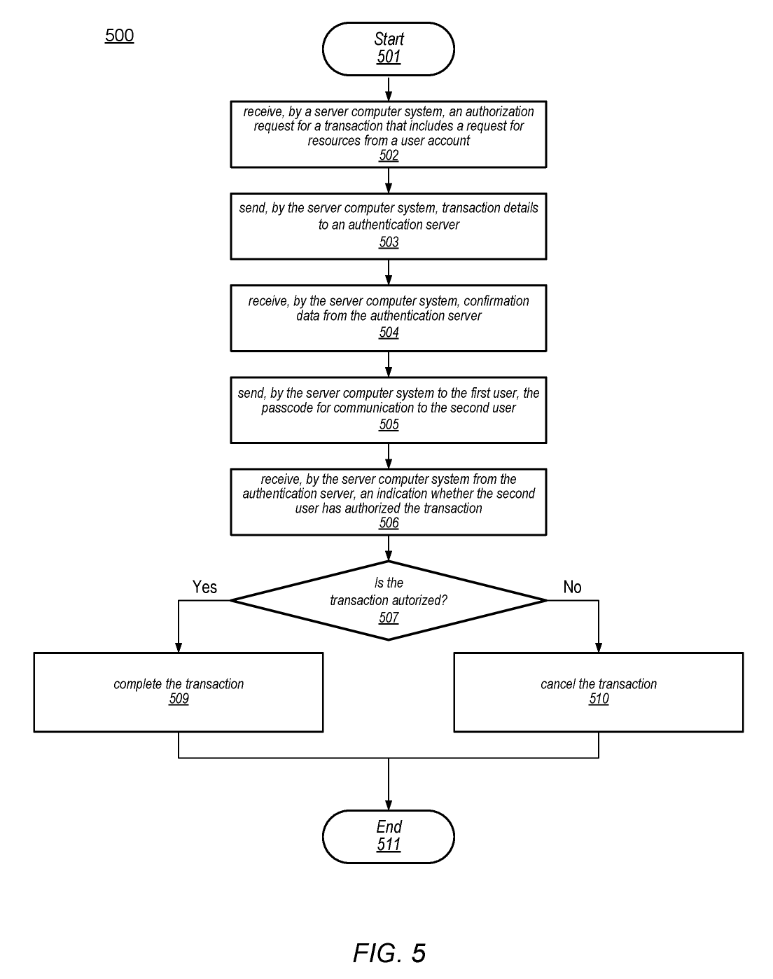

Proceeding to FIG. 5, a flow diagram for an embodiment of a method for receiving and processing a request for a transaction authorization is shown. Method 500 may be applied to a system of networked computer systems and servers, such as, for example, the systems illustrated in FIG. 1. Referring collectively to FIG. 1 and the flow diagram in FIG. 5, the method begins in block 501.

In the illustrated embodiment, a server computer system receives an authorization request from a first user for a transaction that includes a request for resources from a user account (block 502). In the illustrated embodiment, server computer system 101 receives authorization request 110 from first user 103. The request may be to complete a transaction that includes resources from the user account. Authorization request 110 may include an identification value that identifies a second, different user (i.e., second user 104) that has authorization authority for the user account. The identification value may include contact information (e.g., a telephone number, email address, text messaging number) for second user 104 and/or a value that otherwise identifies second user 104.

The server computer system sends transaction details to an authentication server (block 503). Server computer system 101, in the illustrated embodiment, sends transaction details 111 to authentication server 102. Transaction details 111 may include a description of the requested resources, an identity of first user 103, an address or other identity of where the resources are to be delivered, and any other pertinent information that may allow second user 104 to make a judgement if the requested transaction should be approved or denied. Authentication server 102 may be configured to make authorization determinations for the transaction based on receiving a passcode and a reference value from second user 104.

The server computer system receives confirmation data from the authentication server (block 504). In response to receiving transaction details 111, authentication server generates confirmation data 109. Authentication server 102 may generate reference value 113 based on transaction details 111, for example, by using a result of a hashing algorithm performed on transaction details 111 as reference value 113. Authentication server may store transaction details 111, along with confirmation data 109, in a local memory for future access. Authentication server 102 sends confirmation data 109, including reference value 113, to server computer system 101.

In the illustrated embodiment, the server computer system sends the passcode to the first user (block 505). After receiving authorization request 110, server computer system 101 generates passcode 112. In some embodiments, server computer system 101 may wait to receive confirmation data 109 from authentication server 102 and then base generate passcode 112 based on data included in confirmation data 109. For example, server computer system may generate passcode 112 by encrypting reference value 113 using an encryption keyword known by server computer system 101 and authentication server 102. After passcode 112 has been generated, server computer system 101 sends it to first user 103 for communication to the second user.

The server computer system receives, from the authentication server, an indication whether the second user has authorized the first user to perform the transaction (block 506). After receiving passcode 112 and reference value 113, second user initiates a session with authentication server 102, sends authorization data 107 (including reference value 113 and/or passcode 112), and reviews details of the requested transaction. Second user 104 then sends a transaction approval or denial to authentication server 102. Authentication server 102 generates authorization indication 115 based on whether passcode 112 and reference value 113 are received during a session in which second user 104 has been authenticated. Authentication server 102 sends authorization indication 115 to server computer system 101.

Further operations of method 500 may depend on the received indication (block 507). After receiving authorization indication 115 from authentication server 102, server computer system 101 determines if second user 104 approved or denied authorization request 110. If authorization request 110 is approved, then the method moves to block 509 to complete the transaction. Otherwise, the method moves to block 510 to cancel the transaction.

If approved, then the server computer system completes the transaction (block 509). If authorization indication 115 indicates that second user 104 approved authorization request 110, then server computer system 101 completes the transaction. For example, if the transaction corresponds to a purchase from an online merchant, then the resources to be transferred may correspond to funds to pay for the purchase. Server computer system 101 may transfer the funds from the user account of second user 104 to an account associated with server computer system 101. Authorization indication 115 may include details for transferring the funds from the user account of second user 104. It is noted that the transaction is completed without sharing details of the user account of second user 104 with first user 103. Server computer system 101 may, however, send a message to first user 103 indicating that the transaction has been approved and provide relevant details. The method ends in block 511.

If the transaction is denied, then the server computer system cancels the transaction (block 510). If authorization indication 115 indicates that second user 104 denied authorization request 110, then server computer system 101 cancels the transaction. Continuing the example of the purchase from the online merchant, if the transaction is denied, then server computer system 101 may cancel the transaction by deleting items included in an online shopping cart associated with the purchase. Server computer system 101 may also delete any saved versions of authorization request 110, transaction details 111, confirmation data 109 (including reference value 113), and passcode 112. The method ends in block 511.

It is noted that the embodiment of FIG. 5 is one example. The operations described above are directed towards a server computer system receiving an authorization request. In other embodiments, some operations, or portions of operations may be performed by a different entity than what is disclosed. For example, instead of the server computer system generating the password, the authentication server may generate the password in other embodiments. In some embodiments, operations may be performed in a different order and/or some operations may be performed in parallel.

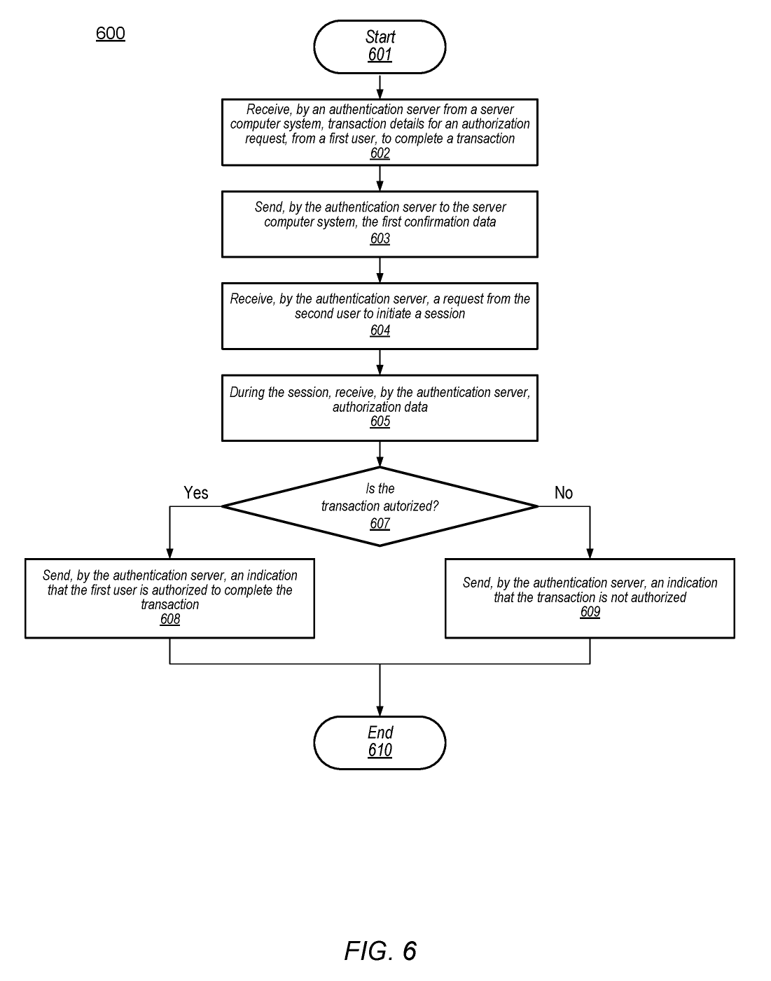

Moving to FIG. 6, a flow diagram for an embodiment of a method for authenticating a request for a transaction authorization is shown. Method 600 may be applied to a system of networked computer systems and servers, such as, for example, the systems illustrated in FIG. 2. Referring collectively to FIG. 2 and method 600, the method begins in block 601.

An authentication server receives, from a server computer system, transaction details corresponding to an authorization request, initiated by a first user, to complete a transaction that includes a request for resources from a user account (block 602). In the illustrated embodiment, First user 203 sends authentication request 210 to server computer system 201, requesting authorization to complete a transaction. In one embodiment, the requested transaction may correspond to a transfer of data from a database for which first user 203 does not have authorization to access. In another embodiment, the requested transaction may correspond to a purchase by first user 203 for which second user 204 is being asked to fund. Authentication server 202 may be configured to authorize the transaction based on receipt of first and second confirmation data (e.g., passcode 212 and reference value 213) from second user 204, who has authorization authority for the user account. In the illustrated embodiment, server computer system 201 sends transaction details 211 to authentication server 202.

In the illustrated embodiment, the authentication server sends, to the server computer system, the first confirmation data (block 603). Authentication server 202 generates confirmation data 209 based on transaction details 211. Transaction details 211 may include any suitable information regarding the requested transaction that may aide second user 204 in determining if the transaction will be approved or denied. Transaction details 211 may include information for identifying first user 203 as well as information for identifying second user 204. Confirmation data 209 includes passcode 212, generated by authentication server 202. Passcode 212 may be based on data included in transaction details 211 or may be randomly generated and then associated with transaction details 211. Authentication server 202 sends confirmation data 209, including passcode 212, to sever computer system 201.

In some embodiments, authentication server 202 also generates reference value 213, based on transaction details 211. In other embodiments, server computer system 201 generates reference value 213 and sends this to authentication server 202 as part of transaction details 211. Authentication server 202 may save transaction details 211, passcode 212, and reference value 213 so these items may be accessed at a later time. In various embodiments, either authentication server 202 or server computer system 201 sends reference value 213 (e.g., the second confirmation data) to second user 204.

The authentication server receives a request from the second user to initiate a session (block 604). After receiving reference value 213, second user 204 sends a request to start a session with authentication server 202. This request may include sending credentials 214 to authentication server 202 as part of a login process to access a user account that is associated with second user 204.

The authentication server receives, during the session with the second user, authorization data that includes the first confirmation data and the second confirmation data (block 605). First user 203 may receive passcode 212 from server computer system 201 and then forward passcode 212 to second user 204. Second user 204 may send authorization data in the form of the first and/or second confirmation data (e.g., passcode 212 and/or reference value 213) to authentication server 202 which may allow second user 204 to view transaction details 211. Second user 204 may use transaction details 211 to determine if the requested transaction will be approved or not.

Subsequent operations of method 600 may depend on the authorization data (block 607). Second user 204 reviews transaction details 211 and makes a decision to either approve or deny the transaction requested by first user 203. In some embodiments, second user 204 may be presented (e.g., on a computer screen) with two options, for example, “Approve” or “Deny.” Selecting one or the other sends additional authorization data to authentication server 202. In other embodiments, second user 204 may be presented with additional choices and/or may be able to enter additional information. For example, second user 204 may be able to add a condition, such as, for example, a time limit for first user 203 to complete the transaction, or may be able to add a message to first user 203 (e.g., a reason for a denial of the transaction request). If second user 204 approves the transaction request, then the method moves to block 608 to send an approval indication to server computer system 201. Otherwise, the method moves to block 609 to send a denial indication.

If the transaction is approved, then the authentication server sends an indication that the first user is authorized to complete the transaction (block 608). In the illustrated embodiment, the indication is based on the authorization data received from second user 204. Authentication server 202 may send additional information to server computer system 201, such as, if available, a message from second user 204 to first user 203. The method ends in block 610.

The authentication server sends an indication that the first user is not authorized to complete the transaction (block 609). The indication, in the illustrated embodiment, is based on the received authorization data. If additional details are available, then authentication server 202 may send these details to server computer system 201. For example, second user 204 may, in some embodiments, provide a reason for denying a transaction request, and may also include instructions to first user 203 in order to get a future transaction request approved. The method ends in block 610.

It is noted that method 600 of FIG. 6 is merely an example. The operations described above are directed towards an authentication server receiving and processing an authorization request. Some operations, in other embodiments, may be performed by a different entity than what is disclosed. In some embodiments, operations may be performed in a different order and/or some operations may be performed in parallel.

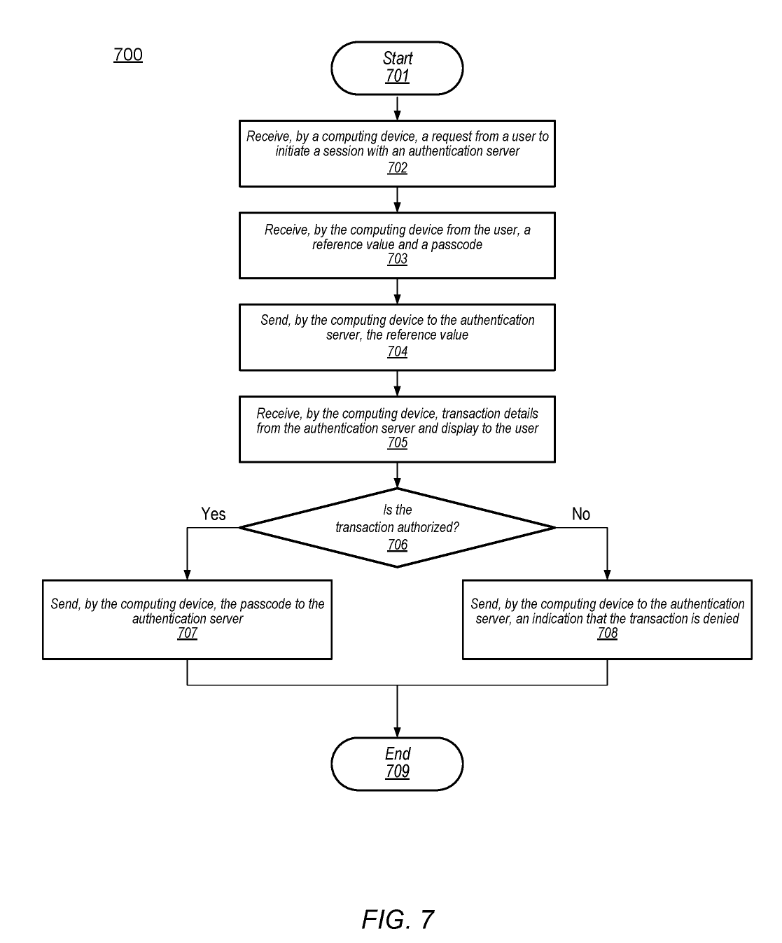

Turning to FIG. 7, a flow diagram for an embodiment of a method for accessing an authentication server is shown. Method 700 may be applied to a system of networked computer systems and servers, such as, for example, the systems illustrated in FIGS. 1 and 2. Referring collectively to FIG. 1 and method 700, the method begins in block 701.

A computing device receives a request from a user to initiate a session with an authentication server (block 702). In the illustrated embodiment, second user 104 uses the computing device to initiate a session with authentication server 102. The computing device may, in various embodiments, correspond to a desktop or laptop personal computer, a mobile device, an automated teller machine, or any other suitable device capable of establishing a network connection to authentication server 102. In some embodiments, the computing device executes an application associated with authentication server 102, such as a banking or other financial application or a database management application. Second user 104 enters credentials 114 into the computing device to login to a user account belonging to, or managed by, second user 104.

The computing device receives, from the user, a reference value and a passcode (block 703). Second user 104, in one embodiment, receives passcode 112 and reference value 113 as part of a request for second user 104 to approve a transaction by first user 103. As part of an approval process, second user 104 enters reference value 113 and passcode 112 into the computing device during the initiated session. Passcode 112, in some embodiments, may be entered into the computing device at a different, later, time than reference value 113, while in other embodiments, both values may be entered during a same operation.

The computing device sends, to the authentication server, the reference value (block 704). After second user 104 enters reference value 113 into the computing device, the computing device sends reference value 113 to authentication server 102. Authentication server 102 may use reference value 113 to retrieve stored details regarding the transaction request (i.e., transaction details 111) associated with reference value 113.

The computing device receives transaction details from the authentication server and displays these details to the user (block 705). Authentication server 102 sends transaction details 111 to the computing device. The computing device displays some or all of the received details for second user 104 to review. The application executing on computing device may, in some embodiments, allow second user 104 to select one or more particular details to view at a given time.

Continuing operations of method 700 may depend on a selected disposition of the transaction request (block 706). Second user 104, in the illustrated embodiment, makes a selection, based on the review of transaction details 111, to approve or deny the requested transaction. If the computing device receives a notice from second user 104 to approve the transaction request, then method 700 moves to block 707 to send passcode 112. Otherwise, the method moves to block 708 to send an indication that the request is denied.

In response to an approval of the transaction request, the computing device sends the passcode to the authentication server (block 707). In the illustrated embodiment, the computing device sends passcode 112 to authentication server 102 to indicate that the associated transaction request is approved. In some embodiments, additional information may be sent along with passcode 112. In other embodiments, passcode 112 may be sent to authorization server 102 along with reference value 113 in block 704. In such embodiments, a different value is sent to indicate the approval of the transaction request. In addition to passcode 112, the computing device may allow second user 104 to enter additional information, such as additional conditions for completing the transaction (e.g., adding a time limit to complete the transaction), or a message to relay to first user 103. The method ends in block 709.

In response to a denial of the transaction request, the computing device sends, to the authentication server, an indication that the transaction is denied (block 708). The computing device, in the illustrated embodiment, sends a value indicating that the transaction request associated with reference value 113 is denied. In addition to the value indicating the denial of the transaction request, the computing device may allow second user 104 to enter additional information, such as a reason for denying the transaction request, or other information to relay to first user 103. The method ends in block 709.

It is noted that the method of FIG. 7 is an example for demonstrating the disclosed embodiments. In other embodiments, some operations may be performed in parallel and/or in a different order.

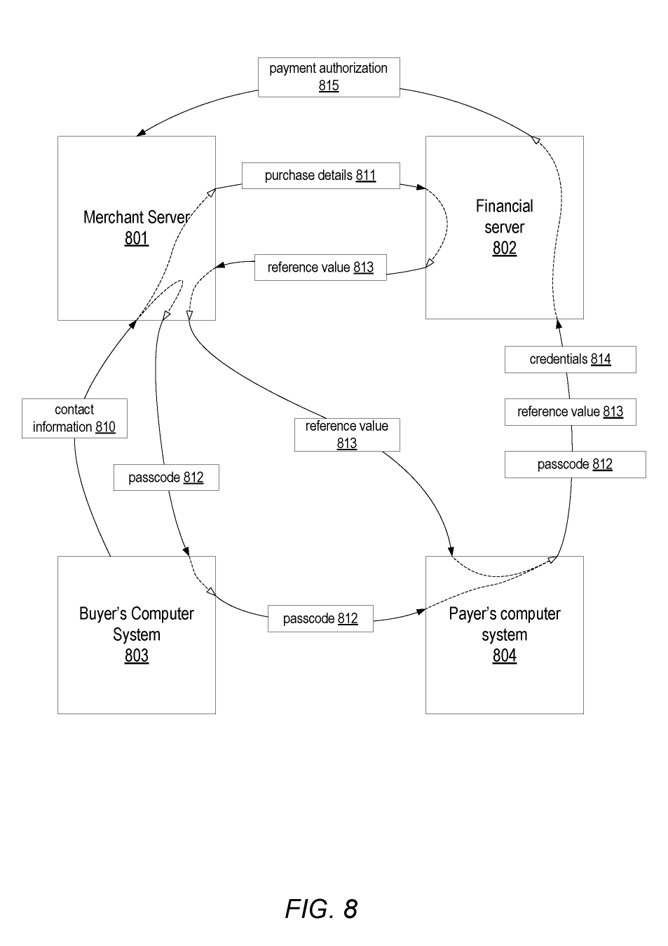

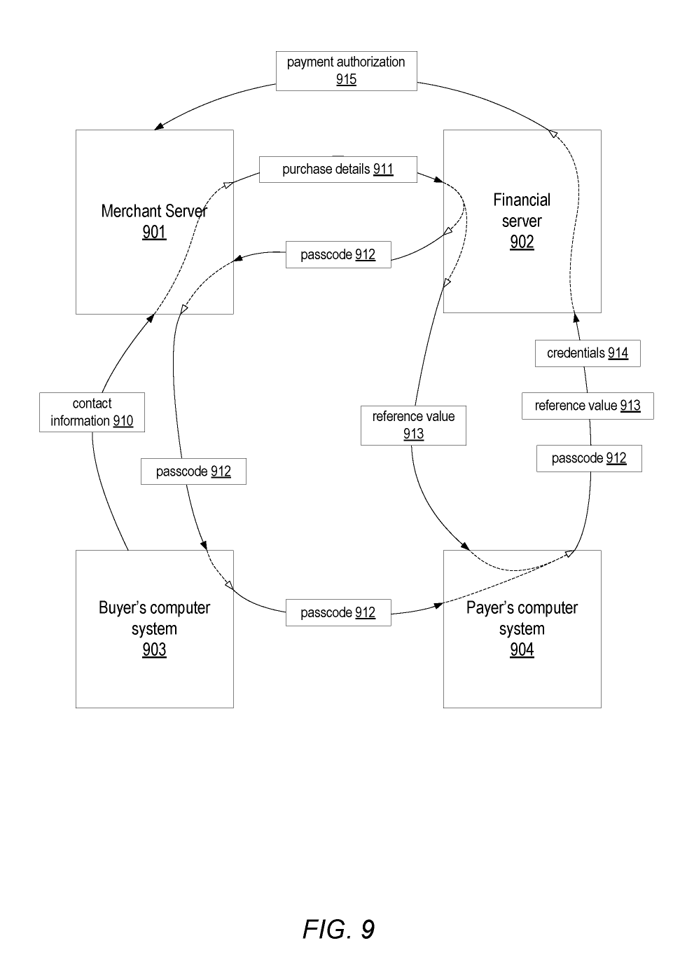

Proceeding now to FIGS. 8 and 9, particular embodiments of the previously disclosed concepts are illustrated. FIG. 8 corresponds to an embodiment of FIG. 1 and FIG. 9 corresponds to an embodiment of FIG. 2, in which, for each illustrated embodiment, a purchase request is sent to a payer for approval of a purchase transaction initiated by a buyer, different than the payer. In the embodiments of FIGS. 8 and 9, the buyer and the payer may be physically located in different regions.

In each illustrated embodiment, the buyer, using buyer's computer system 803/903, initiates a purchase of one or more goods from merchant server 801/901. Buyer's computer system 803/903 may correspond to a desktop or laptop computer, a tablet computer, a smartphone, or any other suitable computer system for accessing an online merchant. Merchant server 801/901 corresponds to one or more computer systems connected to a network, such as, for example, the Internet, and capable of hosting an online storefront. The buyer places an order for the one or more goods, and, as a payment method, selects an option to have another party, i.e., the payer, fund the purchase. Such a payment option is referred to herein as a “payment by reference value” or “payment by reference identification number (ID).”

Merchant server 801/901, in the illustrated embodiments, request contact information for the payer. The buyer enters contact information 810/910 that may include a telephone number, an email address, or any other suitable value that merchant server 801/901 may use to contact the payer. In some embodiments, contact information 810/910 includes an indication of a financial institution that the payer will use to fund the purchase if it is approved. In one embodiment, contact information 810/910 includes an indication of the financial institution as well as a payer ID value that is assigned to the payer by the financial institution. Financial server 802/902 may use this payer ID to retrieve stored contact information for the payer.

Merchant server 801/901 sends purchase details 811/911 to financial server 802/902. Purchase details 811/911 may include various items of information regarding the purchase, such as, for example, the one or more goods being purchased, a shipping address for delivery of the goods, a cost for each of the goods, a total cost of the purchase including taxes and shipping fees, a name or other indication the identity of the buyer, and the like. Purchase details 811/911 may also include some or all of contact information 810/910.

In the embodiment of FIG. 8, merchant server 801 generates passcode 812 and sends passcode 812 to buyer's computer system 803. Merchant server 801 also receives, from financial server 802, reference value 813 which may be used by merchant server 801 and financial server 802 to reference the particular purchase transaction initiated by the buyer. In various embodiments, reference value 813 may be generated by merchant server 801 or financial server 802. Merchant server 801 sends reference value 813 to payer's computer system 804.

The embodiment of FIG. 9 differs from that of FIG. 8. In the embodiment of FIG. 9, financial server 902, in response to receiving purchase details 911, generates passcode 912 and sends passcode 912 to merchant server 901. Reference value 913 may again be generated by either merchant server 901 or financial server 902 and used by each server to reference the particular purchase transaction initiated by the buyer. Financial server 902 sends reference value 913 to payer's computer system 904 using contact information 910.

Remaining operations performed by the illustrated embodiments of FIGS. 8 and 9 are similar. The buyer sends the received passcode 812/912 to the payer using any suitable method, such as, for example, a phone call, a text message, an email, and the like. The payer, after receiving reference value 813/913 and passcode 812/912 initiates a session with financial server 802/902 by logging into an account using credentials 814/914. During the session, the payer retrieves purchase details 811/911 from financial server 802/902 using reference value 813/913. In some embodiments, the payer may also enter passcode 812/912 to retrieve the details, while in other embodiments, the payer may enter passcode 812/912 to approve the buyer's purchase. After reviewing purchase details 811/911, the payer decides to approve or decline the buyer's purchase, and, while the session is active, sends a respective authorization indication to financial server 802/902.

Based on the authorization indication received from the payer, financial server 802/902 sends payment authorization 815/915 to merchant server 801/901. As described above, in some embodiments, the payer may be capable of including additional information that is relayed by financial server 802/902 and merchant server 801/901 to the buyer. If the purchase is approved, then merchant server 801/901 and financial server 802/902 complete a transfer of an appropriate amount of funds to complete the purchase. Merchant server 801/901 may initiate shipment of the purchased goods an address provided by the buyer. Otherwise, if the purchase is declined, then merchant server 801/901 and financial server 802/902 may cancel the purchase request and delete all information associated with the requests, including purchase details 811/911, passcode 812/912, and reference value 813/913.

It is noted, that in the two illustrated embodiments, the payer does not share account details with the buyer, other than indicating an appropriate financial institution to use. Credentials for logging into the financial server or any other details of the payer's account (e.g., credit card or debit card numbers) are not provided to the buyer. In addition, the approval is for a single purchase for which the payer is provided adequate details. The buyer may not use the purchase approval for an alternate or additional purchase. Furthermore, the payer receives at least two values for use to review and approve the purchase, with the two values coming from different entities. If the payer has reason to suspect either entity, then the payer may deny the purchase. For example, if the passcode is received from a mobile device or email address that he payer is not familiar with, this may be a sign of an attempted fraud, i.e., someone trying to fake a legitimate buyer's identity. As another example, if the reference value is received from merchant or financial institution that the payer isn't familiar with or that is known for fraudulent activity, the payer may attempt to contact the buyer for more information or simply decline the purchase.

It is also noted that the embodiments of FIGS. 8 and 9 are examples for demonstrating the disclosed concepts. Variations of the systems and data flow are contemplated in other embodiments. A different number of data items may be used in some embodiments.

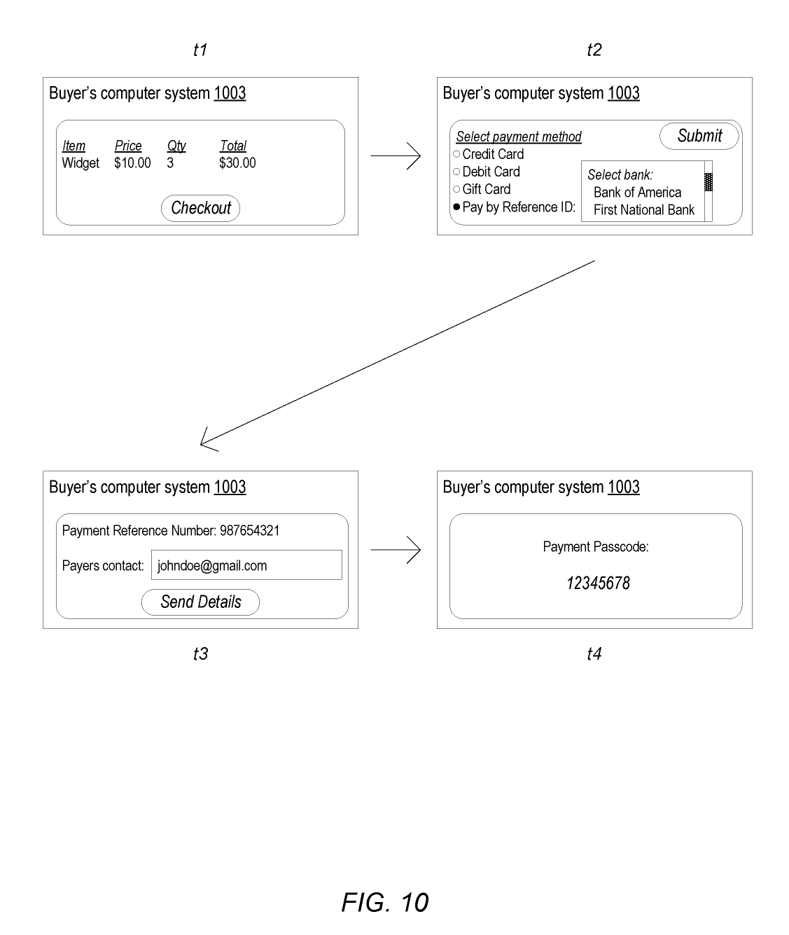

Moving now to FIG. 10, an embodiment of a computer system used to initiate a purchase request is shown at several points in time. Buyer's computer system 1003 may, in various embodiments, correspond to buyer's computer system 803 in FIG. 8 or buyer's computer system 903 in FIG. 9. Buyer's computer system 1003 is shown at times tl through t4, as a buyer initiates a purchase request on a merchant server in order to have an identified payer, different than the buyer, fund the purchase.

At time t1 in the illustrated embodiment, buyer's computer system, 1003 is connected through a network connection to a merchant server, such as, for example, merchant server 801 or 901 in FIGS. 8 and 9, respectively. The buyer has selected items for purchase, in this case, three widgets at a cost of $10.00 per widget. The buyer selects the “Checkout” button causing a payment selection screen to appear on buyer's computer system 1003 at time t2. The buyer selects “pay by Reference ID” in order to have the payer fund the purchase. The displayed interface opens a window for selecting a particular bank associated with the payer. In other embodiments, other financial institutions may be included in the selection list in addition to banks (e.g., credit card companies, credit unions, wire transfer companies such as Western Union, electronic payment options such as PAYPAL™, APPLE PAY™, GOOGLE PAY™, and the like). The buyer selects an appropriate financial institution and then selects the “Submit” button, causing the screen shown at time t3 to be displayed.

At time t3, a payment reference number that is generated by the merchant server, or by a server at the selected financial institution, may be shown. This payment reference number, in these embodiments, may correspond to reference value 813 or 913 in FIGS. 8 and 9. In some embodiments, the payment reference number may not be displayed to the buyer. A space is provided to enter contact information for the payer, in this case, an email address. The buyer selects the “Send Details” button to send the contact information to the merchant server. At time t4, the merchant server, having received the purchase request including the contact information from the buyer, causes buyer's computing device 1003 to display a payment passcode, corresponding to passcode 812 or 912. As previously disclosed, this passcode may be generated by either the merchant server or the financial server. The buyer may send this passcode to the payer using any suitable method.

It is noted that FIG. 10 is merely one example. In other embodiments, additional screens may be displayed. Only basic content adequate for describing the embodiment is shown in FIG. 10. In some embodiments, additional content may be displayed and the information may be displayed in any suitable format.

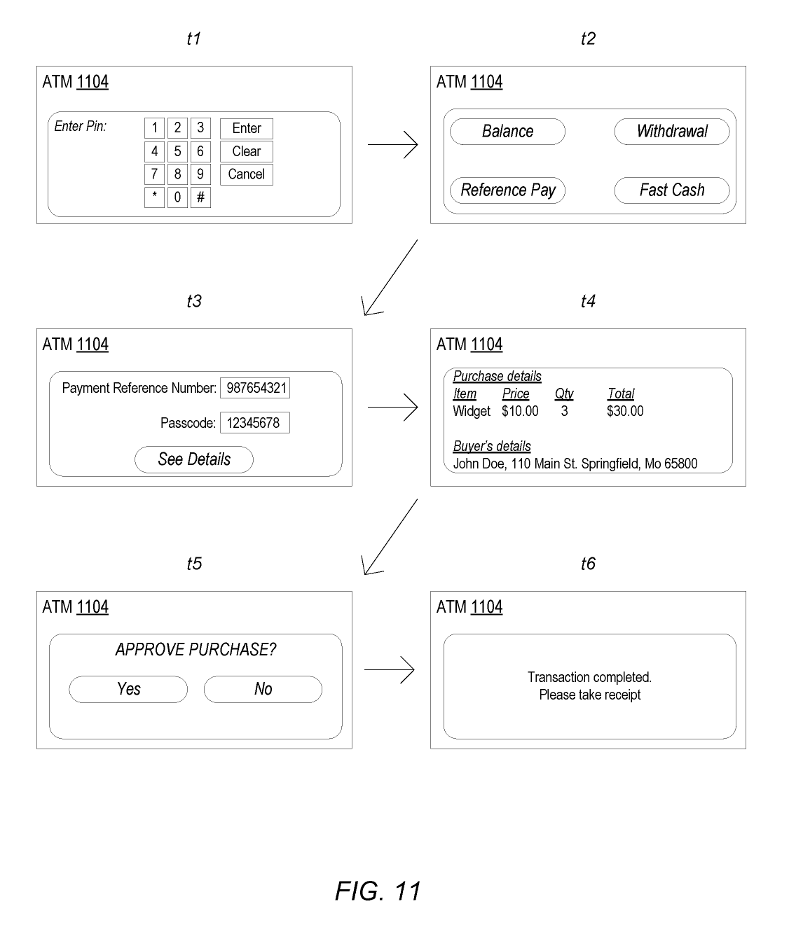

Turning now to FIG. 11, an embodiment of an automatic teller machine (ATM) is displayed at six different points in time. In the illustrated embodiment, ATM 1104 is used by a payer to review and approve or deny a purchase request initiated by a buyer. ATM 1104 may, in various embodiments, correspond to payer's computer system 804 in FIG. 8 or payer's computer system 904 in FIG. 9. ATM 1104 is shown at times tl through t6, as the payer initiates a session with a financial server in order to review the buyer's purchase request.

In the illustrated embodiment, at time t1, the payer initiates a session with the financial server by entering credentials. The credentials may include swiping or inserting a debit card in a card reader of ATM 1104 and then entering a personal identification number (PIN) on the display of ATM 1104. After entering the PIN, ATM 1104 displays a menu as shown at time t2. The payer selects the “Reference Pay” menu option. At time t3, ATM 1104 displays a reference pay screen as shown. The reference pay screen request a payment reference number and a passcode. The payer may have previously received the payment reference number (i.e., a reference value) from a merchant server or the financial server. In addition, the payer may have received the passcode from the buyer. After entering the reference number and the passcode, the payer selects the “See Details” button, causing ATM 1104 to display, at time t4, details of the requested purchase. In this example, goods being purchased, costs, and buyer's details are displayed for the payer to review. After completing the review of the purchase details, ATM 1104 proceeds to an approval screen at time t5. The payer may approve or decline the purchase request. After making an approval decision, ATM 1104 may display a confirmation screen at time t6. In some embodiments, ATM 1104 may also provide a printed receipt for the payer's records.

It is noted that the example in FIG. 11 is one embodiment. In other embodiments, a different number of screens may be displayed. Suitable content for describing the embodiment is shown in FIG. 11. In some embodiments, additional content may be displayed and information may be displayed in any desired format.

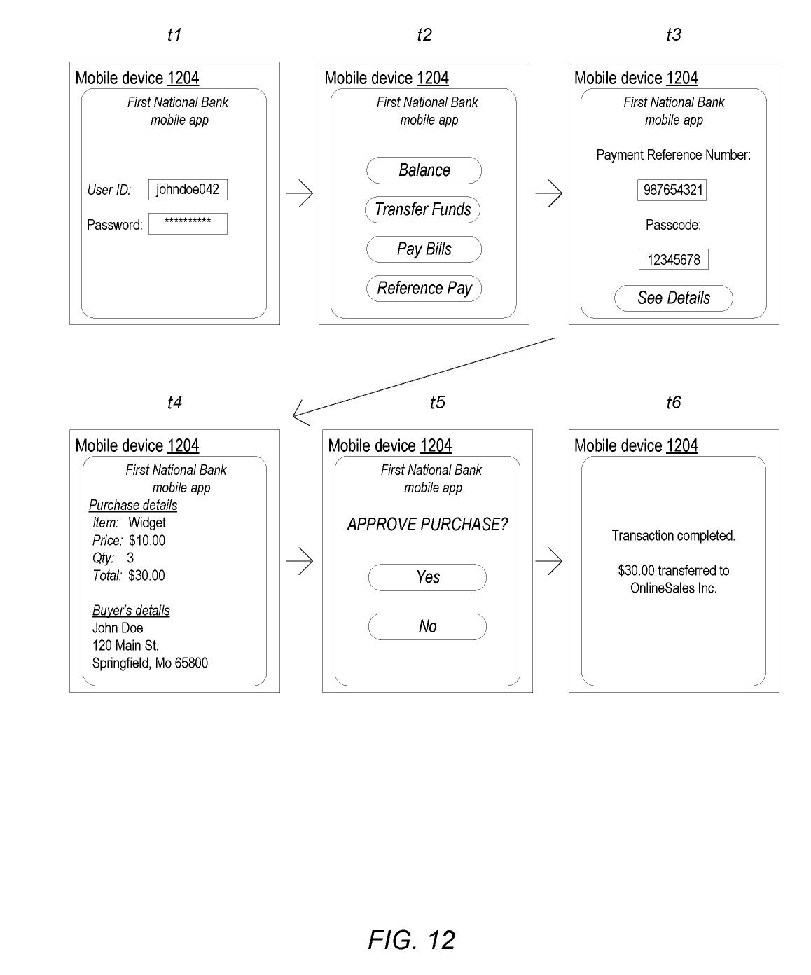

Proceeding to FIG. 12, an embodiment of a mobile device is displayed at six different points in time. Similar to the embodiment of FIG. 11, the illustrated embodiment depicts a payer using mobile device 1204 to review and approve or deny a purchase request initiated by a buyer. Similar to ATM 1104, mobile device 1204 may, in various embodiments, correspond to payer's computer system 804 in FIG. 8 or payer's computer system 904 in FIG. 9. Mobile device 1204 is shown at times tl through t6, as the payer initiates a session with a financial server in order to review the buyer's purchase request.

Mobile device 1204 may correspond to a smartphone, a tablet computer, a laptop computer, a smart wearable device, or any other portable device capable of executing an application to connect to a financial server via a network. In the illustrated embodiment, at time t1, the payer initiates a session with the financial server by launching an application on mobile device 1204. The application may, in some embodiments, be associated with a particular financial institution at which the payer holds an account. The payer enters credentials including a user identification value (ID) and a password to authenticate the payer's identity. In other embodiments, the payer may be capable of using other features of mobile device 1204 in order to initiate the session. For example, the payer may send biometric data such as a fingerprint or facial scan to the application to authenticate that the payer is the account holder and, therefore, authorized to approve a payment to fund a purchase request.

After the payer's identity, mobile device 1204 displays a menu as shown at time t2. The payer selects the “Reference Pay” menu option. At time t3, mobile device 1204 displays a reference pay screen as shown. The payer uses the reference pay screen to enter a payment reference number and a passcode which the payer may have previously received, as described above. After entering the reference number and the passcode, the payer selects the “See Details” button, causing mobile device 1204 to display, at time t4, details of the requested purchase. As in previous examples, goods being purchased, costs, and buyer's details are displayed for the payer to review. After completing the review of the purchase details, mobile device 1204 proceeds to an approval screen at time t5. The payer approves or denies the buyer's purchase request. After the payer makes the decision, mobile device 1204 may display a confirmation screen at time t6.

It is noted that FIG. 12 depicts one example. In other embodiments, additional content may be displayed and information may be displayed in any suitable format. In some embodiments, a different number of screens may be utilized for the purchase approval process.

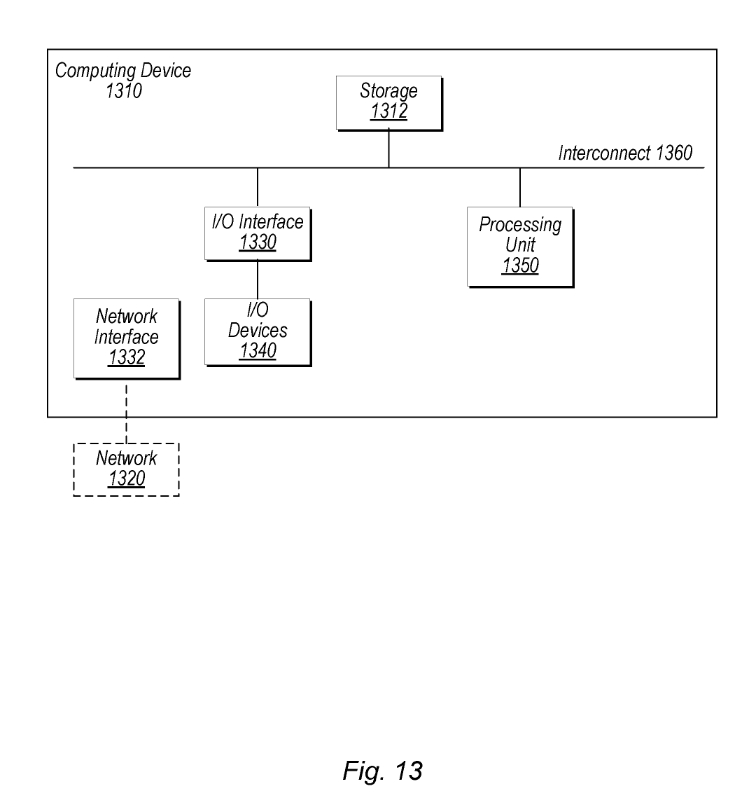

Turning to FIG. 13, a block diagram of an example computer system is illustrated. Computing device 1310, in various embodiments, may correspond to any of the computer systems or computer servers disclosed herein, such as, for example, server computer system 101 in FIG. 1 or buyer's computer system 804 in FIG. 8. Computing device 1310 may be any suitable type of device, including, but not limited to, a personal computer system, desktop computer, mainframe computer system, web server, workstation, or network computer. Furthermore, in some embodiments, computing device 1310 may correspond to a mobile device such as, e.g., a tablet computer, smart phone, a laptop computer, or a wearable computer system. As shown, computing device 1310 includes processing unit 1350, storage 1312, input/output (I/O) interface 1330 coupled via an interconnect 1360 (e.g., a system bus). I/O interface 1330 may be coupled to one or more I/O devices 1340. Computing device 1310 further includes network interface 1332, which may be coupled to network 1320 for communications with, for example, other computing devices.

In various embodiments, processing unit 1350 includes one or more processors. In some embodiments, processing unit 1350 includes one or more coprocessor units. In some embodiments, multiple instances of processing unit 1350 may be coupled to interconnect 860. Processing unit 1350 (or each processor within 1350) may contain a cache or other form of on-board memory. In some embodiments, processing unit 1350 may be implemented as a general-purpose processing unit, and in other embodiments it may be implemented as a special purpose processing unit (e.g., an ASIC). In general, computing device 1310 is not limited to any particular type of processing unit or processor subsystem.

As used herein, the terms “processing unit” or “processing element” refer to circuitry configured to perform operations or to a memory having program instructions stored therein that are executable by one or more processors to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions from any suitable form of non-transitory computer-readable media to perform specified operations.

Storage subsystem 1312 is usable by processing unit 1350 (e.g., to store instructions executable by and data used by processing unit 1350). Storage subsystem 1312 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 1312 may consist solely of volatile memory in one embodiment. Storage subsystem 1312 may store program instructions executable by computing device 1310 using processing unit 1350, including program instructions executable to cause computing device 1310 to implement the various techniques disclosed herein.

In some embodiments, methods and systems disclosed herein may be implemented in whole or in part with computer code that is executable on one or more processor circuits such as processing unit 1350. Thus, various operations described herein may be performed by executing program instructions stored on a non-transitory computer-readable medium and executed by processing unit 1350. The program instructions may be stored in storage subsystem 1312, or provided on any media capable of sharing program code, such as a compact disk (CD) medium, digital versatile disk (DVD) medium, a floppy disk, a flash-based storage, and the like. Additionally, the entire program code, or portions thereof, may be transmitted and downloaded from a software source such as, e.g., via the Internet, or a file transfer protocol (FTP) server, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a mobile computing system such as, for example, in C, C+, HTML, Java, JavaScript, or other such programming languages.

I/O interface 1330 may represent one or more interfaces and may be any of various types of interfaces configured to couple to and communicate with other devices, according to various embodiments. In one embodiment, I/O interface 1330 is a bridge chip from a front-side to one or more back-side buses. I/O interface 1330 may be coupled to one or more I/O devices 1340 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

It is noted that FIG. 13 is merely an example for demonstrating disclosed concepts. Only components and data movement necessary to illustrate these concepts are shown in FIG. 13. Additional and/or different components or data movements may be included in other embodiments.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving, by a server computer system, an authorization request from a first user for a transaction that includes a request for resources from a user account, wherein the authorization request includes an identification value that identifies a second, different user that has authorization authority for the user account;
sending, by the server computer system, transaction details to an authentication server that is configured to make authorization determinations for the transaction based on a passcode and a reference value, wherein the reference value is generated based on the transaction details;
receiving, by the server computer system, confirmation data from the authentication server, wherein the confirmation data is generated by the authentication server based on the transaction details;
sending, by the server computer system to the first user, the passcode for communication to the second user; and
receiving, by the server computer system from the authentication server, an indication whether the second user has authorized the first user to perform the transaction, wherein the indication is generated based on whether the authentication server received, during a session in which the second user has been authenticated, the passcode and the reference value.

2. The method of claim 1, wherein the reference value is generated by the authentication server in response to receiving the transaction details and is included in the confirmation data, and wherein the method further comprises sending, by the server computer system, the reference value to the second user.

3. The method of claim 2, wherein the identification value includes contact information for the second user, and further comprising sending, by the server computer system, the reference value to the second user in an electronic message using the contact information.

4. The method of claim 2, further comprising sending, by the server computer system to the second user, the transaction details along with the reference value, wherein the transaction details include a shipping address for the first user and details of goods associated with the transaction.

5. The method of claim 1, further comprising, in response to receiving the authorization request, generating, by the server computer system, the passcode and including the passcode in the transaction details sent to the authentication server.

6. The method of claim 1, wherein the passcode is generated by the authentication server in response to receiving the transaction details and is included in the confirmation data received by the server computer system from the authentication server.

7. The method of claim 1, wherein the transaction corresponds to a request for a transfer of funds from the user account to pay for a purchase, and wherein the second user has authorization authority to approve the transfer of funds from the user account.

8. The method of claim 7, further comprising, in response to receiving the indication, transferring, by the server computer system, the funds from the user account to an account associated with the server computer system without sharing details of the user account with the first user, wherein the indication includes details for transferring the funds.

9. A method, comprising:
receiving, by an authentication server from a server computer system, transaction details corresponding to an authorization request, initiated by a first user, to complete a transaction that includes a request for resources from a user account, wherein the authentication server is configured to authorize the transaction based on receipt of first and second confirmation data from a second, different user that has authorization authority for the user account, wherein the first confirmation data is generated based on the transaction details;
sending, by the authentication server to the server computer system, the first confirmation data;
receiving, by the authentication server, a request from the second user to initiate a session, wherein the request includes authorization credentials;
receiving, by the authentication server during the session with the second user, authorization data that includes the first confirmation data and the second confirmation data; and
sending, by the authentication server, an indication whether the first user is authorized to complete the transaction, wherein the indication is based on the authorization data.

10. The method of claim 9, further comprising generating, by the authentication server, a reference value and including the reference value in the first confirmation data sent to the server computer system, wherein the reference value identifies the transaction details.

11. The method of claim 9, further comprising:
generating, by the authentication server, a passcode and including the passcode in the first confirmation data sent to the server computer system; and
in response to receiving the passcode from the second user, indicating, to the server computer system by the authentication server, whether the authorization request is approved based on the passcode.

12. The method of claim 9, wherein the first confirmation data corresponds to a reference value and the second confirmation data corresponds to a passcode, and further comprising:
retrieving, by the authentication server from a database, the transaction details using the reference value; and
approving, by the authentication server, the authorization request based on the passcode corresponding to the transaction details.

13. The method of claim 9, further comprising:
receiving, by the authentication server from an automated teller machine, the request from the second user to initiate the session; and
receiving, by the authentication server from the automated teller machine, the authorization data from the second user.

14. The method of claim 9, further comprising:
receiving, by the authentication server from an application installed on a mobile device, the request from the second user to initiate a session; and
receiving, by the authentication server from the application installed on a mobile device, the authorization data from the second user.

15. The method of claim 9, wherein the transaction corresponds to a request for a transfer of funds from the user account, and wherein the second user has authorization authority to approve the transfer of funds from the user account.

16. The method of claim 15, wherein the first and second confirmation data are valid for a particular amount of time and further comprising denying, by the authentication server, the transaction in response to determining that the particular amount of time has expired.

17. A non-transitory, computer-readable medium storing instructions that, when executed by a computer system, cause the computer system to perform operations comprising:
receiving, by a server computer system, an authorization request from a first user for a transaction, wherein the authorization request includes an identification value that identifies a second, different user that has authorization authority for the transaction;
sending, by the server computer system, transaction details to an authentication server that is configured to make authorization determinations for the transaction based on a passcode and a reference value, wherein the reference value is generated based on the transaction details;
receiving, by the server computer system, confirmation data from the authentication server, wherein the confirmation data is generated by the authentication server based on the transaction details;
sending, by the server computer system to the first user, the passcode for communication to the second user; and
receiving, by the server computer system from the authentication server, an indication whether the second user has authorized the first user to perform the transaction, wherein the indication is generated based on whether the authentication server received, during a session in which the second user has been authenticated, the passcode and the reference value.

18. The non-transitory, computer-readable medium of claim 17, wherein the operations further comprise sending the confirmation data to the second user by sending an electronic message with the confirmation data to contact information included in the identification value.

19. The non-transitory, computer-readable medium of claim 17, wherein the operations further comprise, in response to receiving the authorization request, generating, using a random number generation algorithm, the passcode, and including the passcode in the transaction details sent to the authentication server.

20. The non-transitory, computer-readable medium of claim 17, wherein the operations further comprise receiving the passcode from the authentication server.
